(19) United States
(12) Patent Application Publication
(10) Pub. No.: US 2004/0148220 A1
(43) Pub. Date: Jul. 29, 2004

(54) System and method for candidate management

(76) Inventors: Robert B. Freeman JR., Arlington, TX (US); Richard Logan Bilyea, Fort Worth, TX (US); Tirumala Kumar Kanakamedala, Irving, TX (US)

Correspondence Address: J. Michael Martinez de Andino, Esq., HUNTON & WILLIAMS, Riverfront Plaza, East Tower, 951 East Byrd Street, Richmond, VA, 23219-4074, US

(21) Appl. No.: 10/351,870

(22) Filed: Jan. 27, 2003

(51) Int. Cl. G06F 17/60

(52) U.S. Cl. 705/11

(57) ABSTRACT

A method of facilitating a candidate to apply for a professional position is disclosed. The method comprises accepting candidate information from the candidate. The candidate information is assessed, and the candidate information is transferred to an associated candidate pool based on the candidate information. The method further comprises communicating with the candidate based on the associated candidate pool. Lastly, the method includes receiving application input from the candidate for the professional position. A method of managing a candidate is also disclosed. The method comprises assessing candidate information provided by the candidate, the candidate information including required information and professional profile information, placing the candidate in an associated candidate pool based on the professional profile information, and communicating with the candidate based on the associated candidate pool, wherein at least one communication is sent to the candidate designed to encourage the candidate to apply for a professional position.

### BACKGROUND OF THE INVENTION

The invention relates generally to systems and methods of facilitating a candidate to apply for a professional position.

In today's economy, business is done differently than it was in the past. Companies are constantly seeking new ways to attract new employees and get the most talented workers. Unfortunately, there is a large disconnect between many professionals seeking employment, and the businesses that need their service. With the growing familiarity of the Internet, many people have turned to the World Wide Web to find employment opportunities and investigate company information. Although the Web can provide many leads, few people are actually hired over the Web due to complications in various hiring processes.

One of the largest hurdles in finding employees over the Internet is simply getting the right candidates to apply for available positions. Although job opportunities may be posted on the Internet, there are many reasons that good candidates may not apply for those positions. For example, consider an employee that is currently employed, but considering changing companies. This person may not wish to take the formal step of applying for the job opportunity when it is discovered, but may decide to do so in the future. In another example, someone may discover a job opportunity with a company that is not a good fit, but the individual has a high interest in the company, which plans to offer a more fitting job in the near future. In both cases, it would be beneficial to have a way of maintaining contact with this individual so that when the time arrives, the job opportunity may be applied for.

Accordingly, the invention provides systems and methods for facilitating candidates to apply for professional positions, that overcome the disadvantages of known systems and methods while offering features not present in known systems and methods.

### SUMMARY OF THE INVENTION

In accordance with one embodiment of the invention, a method of facilitating a candidate to apply for a professional position is disclosed. The method comprises accepting candidate information from the applicant, assessing the candidate information, transferring the candidate information to an associated candidate pool, communicating with the candidate based on the associated candidate pool, and receiving application input from the applicant for the professional position, for example.

A method of managing a candidate, in one embodiment of the invention, comprises assessing candidate information provided by the candidate, the candidate information including required information and professional profile information, placing the candidate in an associated candidate pool based on the professional profile information, and communicating with the candidate based on the associated candidate pool, wherein at least one communication is sent to the candidate designed to encourage the candidate to apply for a professional position, for example.

In another aspect of the invention, a candidate management system is disclosed. The candidate management system comprises means for accepting candidate information from a candidate system, means for assessing the candidate information, means for transferring the candidate information to an associated candidate pool, means for communicating with the candidate system based on the associated candidate pool, and means for receiving application input from the candidate system for the professional position, for example.

A candidate management system, in another aspect of the invention, comprises means for assessing candidate information provided by a candidate, the candidate information including required information and professional profile information, means for placing the candidate information in an associated candidate pool based on the professional profile information, and means for communicating with the candidate based on the associated candidate pool to encourage the candidate to apply for a professional position, for example.

### BRIEF DESCRIPTION OF THE DRAWINGS

The present invention can be more fully understood by reading the following detailed description of the presently preferred embodiments together with the accompanying drawings, in which like reference indicators are used to designate like elements, and in which:

FIG. 1 is a flowchart illustrating a method of facilitating a candidate to apply for a professional position in accordance with one embodiment of the invention;

FIG. 2 is an illustrative user interface displaying candidate records in accordance with one embodiment of the invention;

FIG. 3 is an illustrative user interface for transferring candidates in accordance with one embodiment of the invention;

FIG. 4 is an illustrative user interface of a candidate pool communication in accordance with one embodiment of the invention;

FIG. 5 is an illustrative user interface of a candidate communication in accordance with one embodiment of the invention;

FIG. 6 is an illustrative user interface of an event log in accordance with one embodiment of the invention;

FIG. 7 is a flowchart illustrating a method of utilizing a candidate management system in accordance with one embodiment of the invention;

FIG. 8 is a flowchart illustrating the administrator features of FIG. 7 in further detail in accordance with one embodiment of the invention;

FIG. 9 is a flowchart illustrating the candidate management features of FIG. 8 in further detail in accordance with one embodiment of the invention;

FIG. 10 is an illustrative user interface displaying job search features in accordance with one embodiment of the invention;

FIG. 11 is a flowchart illustrating the non-administrator features of FIG. 7 in further detail in accordance with one embodiment of the invention;

FIG. 12 is a schematic of an illustrative candidate management system in accordance with one embodiment of the invention;

FIG. 13 is a schematic of the memory portion of FIG. 12 in further detail in accordance with one embodiment of the invention; and

FIG. 14 is a schematic of the user interface portion of FIG. 12 in further detail in accordance with one embodiment of the invention.

### DETAILED DESCRIPTION OF PREFERRED EMBODIMENTS

In accordance with one aspect of the invention, a method of facilitating a candidate to apply for a professional position is disclosed. The method comprises accepting candidate information from the candidate. The candidate information is assessed, and the candidate information is transferred to an associated candidate pool based on the candidate information. The method further comprises communicating with the candidate based on the associated candidate pool. Lastly, the method includes receiving application input from the candidate for the professional position. Further details of the systems and methods of the invention will hereinafter be described.

As used herein, a “candidate” includes a user of a candidate management system that has submitted candidate information to the candidate management system. Prior to becoming a candidate, an individual that utilizes the candidate management system is generally referred to as a user. Once a candidate chooses to apply for a position posted by the candidate management system, the candidate then becomes an applicant.

As used herein, a “position” or “profession” or “professional position” includes any occupation or vocation requiring training in the liberal arts or the sciences and advanced study in a specialized field. This may include, but not be limited to, nurses, doctors, allied health professionals (pharmacy, nuclear medicine technicians, ultra sound technicians, speech pathologists, dieticians, respiratory therapists, occupational therapists, physical therapists), engineers, information technology professionals, computer programmers, accountants, airplane pilots, commercial vehicle operators, commercial vessel operators, lawyers, paralegals, and any other vocation or occupation that requires an individual to obtain a license or certification for practice within that profession, for example.

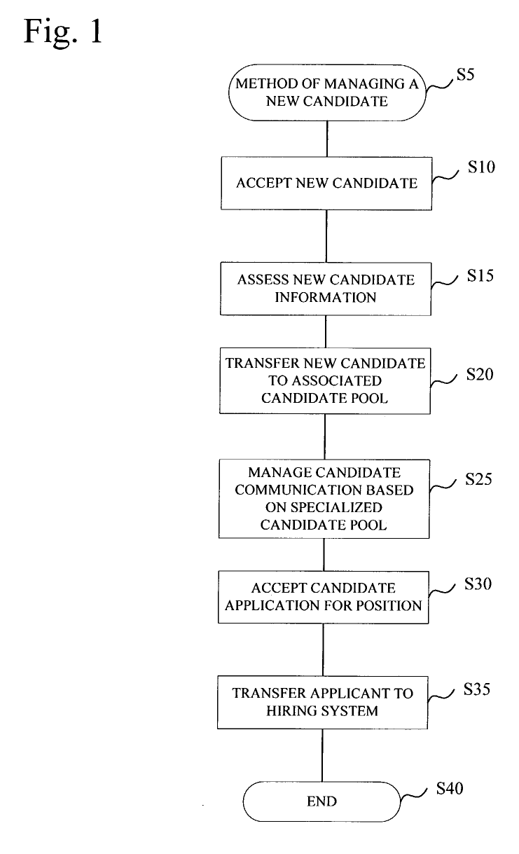

FIG. 1 is a flowchart illustrating a method of facilitating a candidate to apply for a professional position in accordance with one embodiment of the invention. As shown in FIG. 1, the process begins in step S5, and passes to step S10, wherein candidate information is accepted from a candidate. This information is generally received by a candidate management system, as described in further detail below. Candidate information generally includes two types of information: (1) required information, i.e., basic information about the candidate, and (2) professional profile information, i.e., job-related information related to the candidate's professional qualifications.

Required information may include the candidate's name, classification (as related to the candidate's profession), address, e-mail address, a candidate user name and a password. Although users of the candidate management system may search for job postings on the system before registering, users may not apply for a job, express interest in a position, or request additional information about future openings, without providing the required information.

If a candidate does not have an e-mail address, the candidate management system may create a unique e-mail account for the candidate so that the candidate may receive e-mail communications from the candidate management system. This also facilitates communication with the candidate. In such situations, the candidate management system will generally treat the e-mail account created for the candidate as the candidate's e-mail address of record.

Aside from the required information, candidates will also be required to supply certain information related to the candidate's professional background. This professional profile information becomes the basis for determining where the candidate will be placed, i.e., which candidate pool, for ongoing management by administrators and the candidate management system. Although the professional profile information will generally depend on the type of profession involved, some of the types of information requested may include the candidate's specialty, desired job or workplace setting, desired job type, desired weekly hours, job start availability, years experience, career goals, location preference, notification preferences, and resume preferences, for example.

To provide further illustration, consider the types of information that may be requested of nursing candidates for their professional profiles. Upon supplying the required information, the candidate may be prompted to select various options for several fields of information including: Specialty, Setting, Job Type, Weekly Hours, Availability, Years Experience, Career Goals, Location Preference, Notification Preferences, and Resume Preferences. Although several options may generally be provided for each field, the following provide illustrative selections for each field.

For Specialty, the nursing candidate may be able to select from, among several other choices, Appeals and Denials, Burn Unit, Cardiac Care-Intensive Care Unit, Case Management. Certified Legal Nurse Consultant, Certified Nurse Aide, Certified Operating Room Technician, Charge Nurse, Chart Reviews, Child Care, Companion, Concurrent Review, Credentialing/Recredentialing, Dialysis, Disability Management, Disease Management, Doctor's Office, Emergency Room, Floor Nurse, Geriatrics, Home Care, Home Health Aide, Hospital DCP, Intensive Care Unit, Labor & Delivery, Managed Care, Management, Maternal/Child Care, Medical Case Management, Medical Laboratory Technician, Medical Social Worker, Medical/Surgical, Mental Health Worker, Neonatal-Intensive Care Unit, Neurology, Nursery, Nursing Home, Obstetrical Gynecological, Occupational Health, Oncology, Operating Room, Operating Room Technician, Pediatric, Pediatric-Intensive Care Unit, Phlebotomist, Physical Therapist, Physical Therapist Assistant, PIP, Pre-Certification, Prospective Review, Psychiatric/Mental Health, Psychiatric/Mental Health Technician, Pulmonary, Quality Assurance, Quality Audits, Quality Project Leader, Radiographer/Radiological Technician, Recovery Room, Rehabilitation, Research, Respiratory Therapist, Retrospective Review, Risk Management, Social Work Assistant, Speech Language Pathologist, Staffing, Substance Abuse, Supervising, Surgical Floor, Telemetry, Total Quality Management, Transplant, Urology, Utilization Review, Women's Health, Workers'Compensation Case Management.

For Setting, the nursing candidate may select from, among several other choices, clinic, doctor's office, home care, hospital, or nursing home. For Job Type, the nursing candidate may choose from part time, intern, contract, full time, or per diem. For Weekly Hours, the nursing candidate may be able to select from 5-10 hours, 11-15 hours, 16-20 hours, 21-25 hours, 26-30 hours, 31-35 hours, 35-40 hours, or more than 40 hours, for example. The nursing candidate's Availability may range from negotiable, immediate, 2 weeks, 1 month, 2 months, or 3+months, for example. Years Experience may includes choices of 1-3 years, 3-5 years, 5-7 years, 7-10 years, or 10+ years, for example. Under Career goals, which may be associated with Job Type, the nursing candidate may be able to select from per diem only, per diem to full time, per diem to contract, per diem to permanent, contracts only, or contract to permanent, for example.

For Location Preference, the candidate may select a geographic location, such as a state, locality within a state, metropolitan statistical area or any combination of the above. Using the State of Georgia as an example, some options, among several others, may include GA—Atlanta, Ga.—Athens, or GA—Augusta. The Notification Preferences describe the type of notification a candidate wishes to receive from the candidate management system. These options may include a request for immediate information about applying online, future informational contact, or periodic (i.e., daily, weekly or immediate) communications, by e-mail, for example, when job postings become available that match the candidate's professional profile. In at least one embodiment, candidates that do not select a notification preference, or complete the candidate's information will be placed in a general candidate pool in the candidate management system.

While the above described candidate information types, categories, fields and selections are intended to provide illustrative options for nursing candidates' professional profile information, these embodiments are not intended to be exclusive. These options can be modified or combined in any manner, and additional or fewer types of information may be utilized. Accordingly, it should be appreciated that the types of information required and requested for operation of the system and methods of the invention should generally be based upon the professional positions for which the candidate management system is designed to encourage applications from candidates. Furthermore, the candidate information submitted by the candidate may be updated or edited, using the candidate's user name and password, as needed by the candidate following the initial information submission.

Utilizing the candidate information received from a candidate, an administrator can manage a candidate. In at least one embodiment of the invention, the candidate submits information to a candidate management system. An illustrative candidate management system may comprise a computer operating system or other processing machine in network communication with various user, candidate, applicant and administrator systems. For example, a candidate management system may include a system displaying an interactive website whereby users can search for job related information, register with the candidate management system, apply for positions or utilize other candidate features described in detail below. Administrators can access the candidate management system to create, post and administer job openings, search through available candidates, and manage communications with candidates to encourage them to apply for listed positions.

Once candidate information is received by a candidate management system, it is generally stored for later analysis by either an administrator or the candidate management system. The storing of the information may include creating an associated candidate record for each candidate that information is received from. The candidate information would then be stored in the individual candidate's record. In one embodiment of the invention, once a candidate submits information and the system creates an associated candidate record, the associated candidate record is placed into a new candidate pool.

As shown in FIG. 1, once candidate information has been accepted, the candidate information is assessed in step S15. The candidate information may be assessed by an administrator or the candidate management system to determine which candidate pool the candidate should be placed in for continued management and communication. The candidate's information generally becomes the basis for determining which candidate pool the candidate will be placed within. The assessment of the candidate's information, including the professional profile information, may be completed by either an administrator, or in some embodiments, by the candidate management system when provided with predefined criteria for sorting candidates into the various candidate pools.

An administrator can assess a candidate's information by reviewing the information provided in the candidate's record. Illustratively, an administrator may choose to view all new candidates that have recently submitted information but have not been transferred from the new candidate pool. This may generally be accomplished by an administrator accessing the candidate management system, providing her administrator login input, and viewing the new candidate records on an administrator user interface. These aspects of the invention allows for multiple administrators to assess new candidates and transfer them to a specified candidate pool if desired. The new candidates are displayed in the new candidate pool, along with the information they submitted.

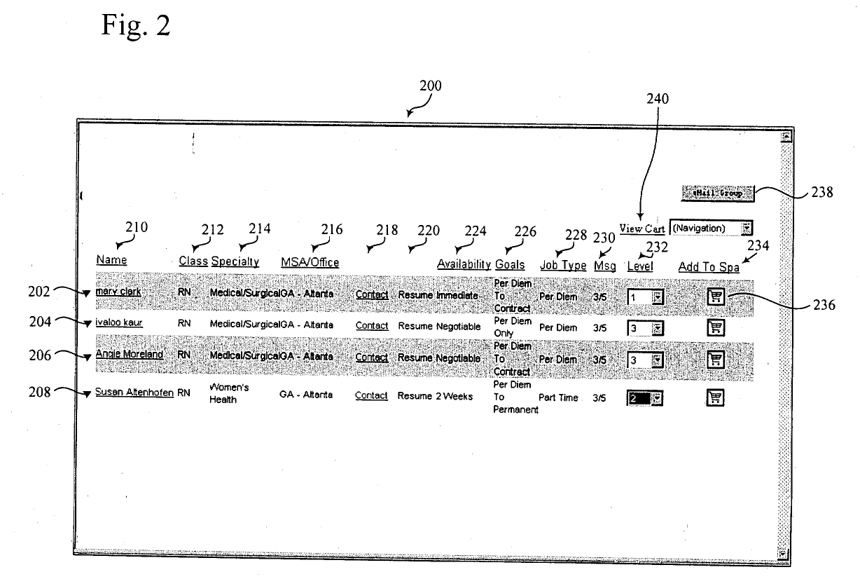

FIG. 2 is an illustrative user interface for displaying candidate records in accordance with one embodiment of the invention. As shown in FIG. 2, user interface 200 is displaying candidate records that may appear in a new candidate pool for nursing candidates. Candidate records 202, 204, 206 and 208, represent four different candidates, with the corresponding candidate information displayed across the row. Candidate information and administrator tools are provided in the various fields 210-234, for the list of candidate records. As shown in FIG. 2, these fields include “Name” field 210, “Class” field 212 (i.e., classification under the professional profile information), “Specialty” field 214, “MSA/Office” field 216 (i.e., location preference under the professional profile information), “contact” field 218, “resume” field 220, “Availability” field 224, “Goals” field 226 (i.e., career goals under the professional profile information), “Job Type” field 228, “Msg” field 230 (i.e., total number of unread messages in the event log, from the candidate, versus the total number of messages in the event log), “Level” field 232, “Add to Spa” field 234, for example.

User interface 200 also provides the administrator with several tools for managing candidates. For example, by selecting a candidate's name, such as “mary clark” in candidate record 202, the administrator can view the event log for the candidate record 202. By selecting “contact” in candidate record 202, the administrator can send an e-mail directly to the candidate's e-mail address of record and automatically store a copy as a new candidate event in the event log for candidate record 202. Additionally, the administrator can sort the new candidates by selecting the heading of any field 210-234, or other category of information provided, make comments to or evaluate the candidate's, such as giving an individual candidate a level of prioritization by selecting “Level” field for an individual candidate record, or transfer a candidate from the new candidate pool into a specialized pool for continued management by selecting an icon in the “Add to Spa” field 234 for a candidate record. For example, the administrator could choose to transfer “mary clark” by selecting icon 236 in candidate record 202. Selecting icon 236 will present the administrator with a separate user interface, for transferring the candidate. The administrator may also select the “eMail group” tool 238 to send an e-mail message to the entire candidate pool. Selecting “view cart” tool 240 allows the administrator to view a separate user interface displaying those candidates that have been selected for transfer. It should also be appreciate that the user interface of this embodiment may be utilized for each specialized candidate pool as well.

Alternatively, the candidate management system may be utilized to assess the new candidate information and determine which specialized candidate pool the candidate should be placed in. The candidate management system would handle the sorting of the new candidates into candidate pools, directed by predetermined criteria set by administrators. This would allow administrators to focus on candidate management and communication rather than where a candidate should be placed. The candidate management system could then assess candidate information upon receipt of new information, or could perform a periodic check of the new information received. The candidate management may also deliver an alert to the administrator responsible for a particular candidate pool when a new candidate is placed there.

The placement of candidates into the appropriate candidate pool is important for the continued recruitment of the candidate designed with the goal of encouraging the candidate to apply for a posted position. To provide further illustration, consider an administrator for nursing candidates that becomes aware of a need for nursing applicants in a certain area, such as Baltimore, Md. The administrator may create a specialized candidate pool for nursing candidates that are located within, or interested in working in the Baltimore area. When the administrator reviews new or existing candidates that have submitted information to the candidate management system, those candidates that chose Baltimore as their desired location can be selected for transfer to the specialized Baltimore pool. Once transferred to the specialized Baltimore candidate pool, the administrator can manage contact with the candidates. Accordingly, the administrator can send targeted communications to each candidate in the Baltimore pool, including further information on Baltimore positions, each communication being designed to encourage candidate application.

Returning to FIG. 1, in step S20, following the assessment of new candidate information, new candidates are transferred to an associated candidate pool based on the assessment of the candidate information provided. This generally includes transferring the candidate record to a different pool chosen by the administrator or system.

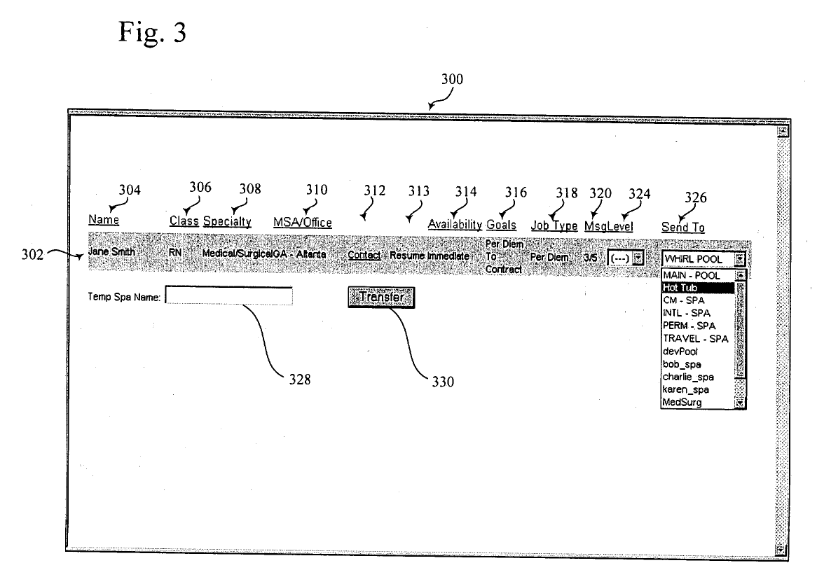

FIG. 3 is an illustrative user interface for transferring candidates in accordance with one embodiment of the invention. As shown in FIG. 3, user interface displays candidate record 302, which represents the candidate “Jane Smith,” that the administrator has chosen to transfer. Similar to user interface 200, the candidate's information and administrator tools are provided in the various fields 304-330, respectively. For transferring the candidate record 302, the “Send To” field 319 provides a list of candidate pools that the candidate can be transferred into. Once a candidate pool is selected, the transfer tool 330 allows the administrator to complete the transfer. A temporary pool field 328 is provided for directing the transfer of the candidate to a candidate pool not found in the “Send To” field 319 options. It should be appreciated that those candidates that do not meet the requirements of any specialized pool may be removed from the new candidate pool and placed in a general candidate pool. If needs or job opportunities arise later, an administrator or the candidate management system can transfer these candidates as needed. Additionally, if candidates in the general candidate pool submit an interest in or apply for a particular position, the candidate will generally be transferred to the candidate pool associated with the posted position. In this respect, each posted position will be associated with a specific candidate pool, as determined by an administrator when the posting was created

Once the candidates have been transferred to associated candidate pools, in step S25, communications with the candidates are managed by administrators responsible for each candidate pool. For example, in the nursing candidate pool created for those interested in working in Baltimore, each candidate may receive a communication from the Baltimore administrator encouraging them to apply for a Baltimore job opportunity. This may include any type of communication with the candidate, i.e., over the telephone, through e-mail or other electronic communication, for example. The communications with the candidates in a particular pool are designed to encourage the candidates to apply for related positions. Although a candidate will generally receive a communication based on the candidate pool she occupies, the communication may be a mass communication directed to the entire pool, or a personalized communication sent only to that candidate.

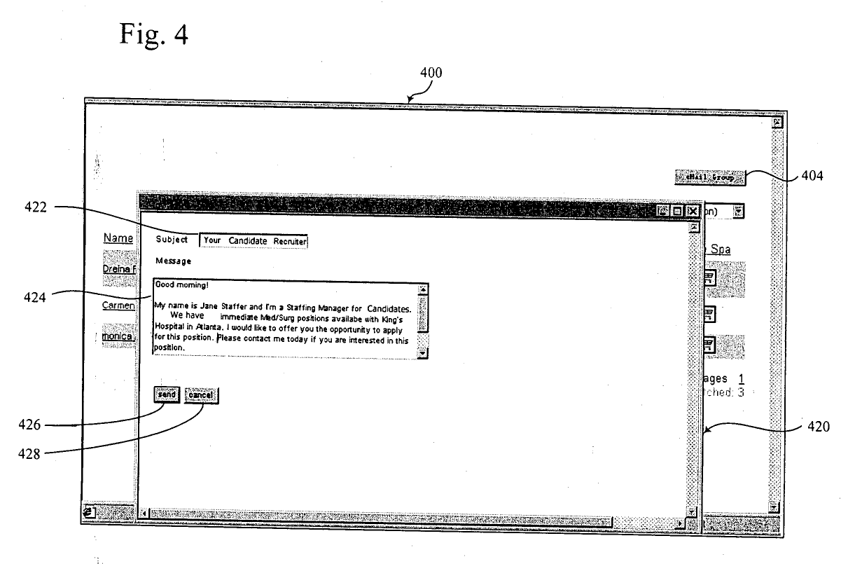

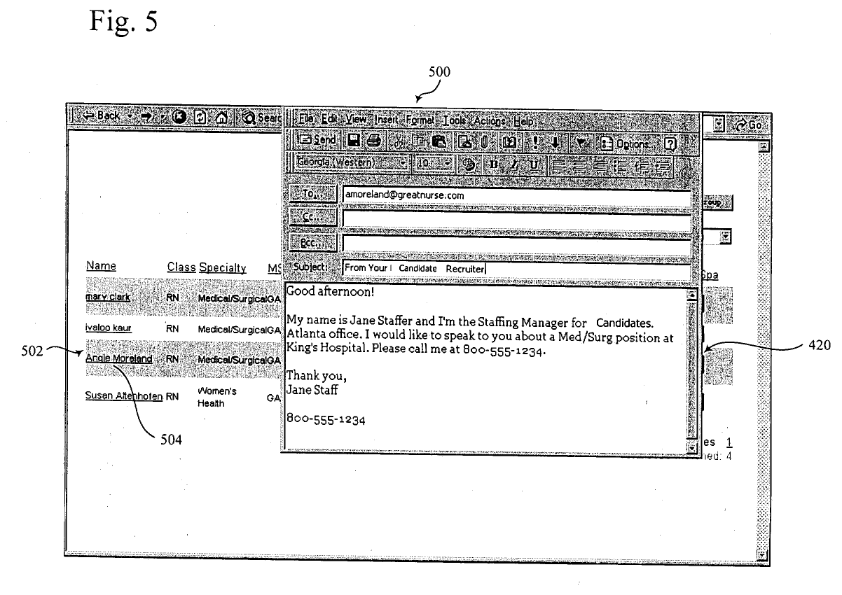

FIG. 4 is an illustrative user interface for sending a candidate communication in accordance with one embodiment of the invention. As shown in FIG. 4, following the selection of the “eMail Group” tool 404 from user interface 400, an e-mail window 420 is presented to the administrator for creating and sending the message. In this embodiment, the e-mail is directed to the each candidate in the pool the administrator is working with. The e-mail window 420 provides a subject field 422, a message field 424, a send tool 426 for sending the message, and a cancel tool 428 for canceling the message and closing e-mail window 420. FIG. 5 provides yet another user interface for sending a candidate communication. As described above, once the candidate name 504 is selected from candidate record 502 in user interface 500, an e-mail window 520 is presented to the administrator for sending a message solely to the candidate selected, in this example “Angie Moreland.” The e-mail message may include data and other information for electronic mail communications.

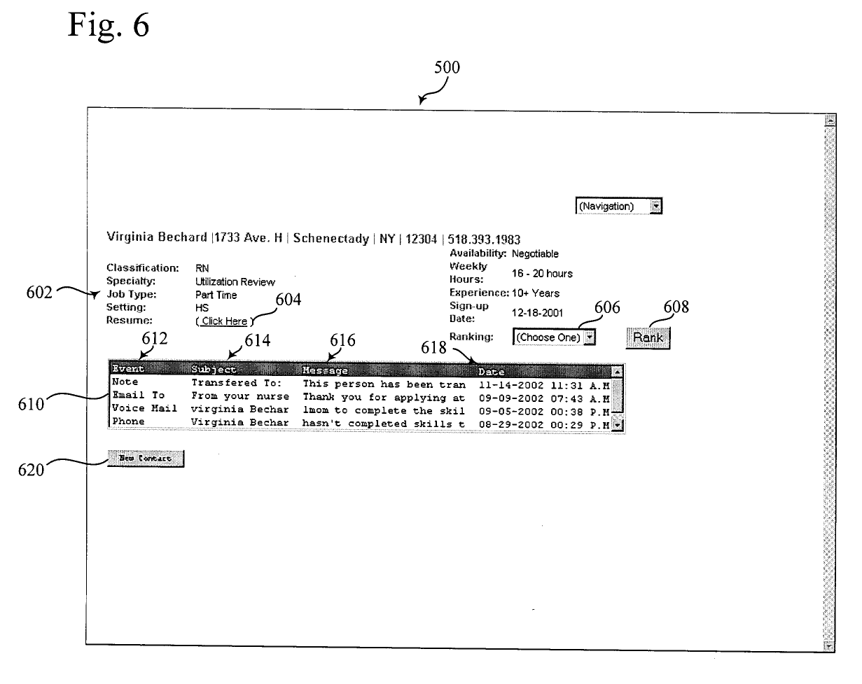

An entry for each candidate communication is stored with each candidate's record to provide a full history of contact with each candidate. Accordingly, each candidate record will also include an event log. FIG. 6 is an illustrative user interface displaying an event log. The user interface 600 includes candidate information portion 602, resume viewing tool 604, ranking field 606, rank tool 608, event log 610, which may include data and information divided into fields, such as event field 612, subject field 614, message field 616, and date field 618, respectively. The event log 610 maintains a list of all communications, or candidate events, between the candidate and the administrator that are sent to or through the candidate management system, and other contacts between the candidate and administrators. An event may include any type of candidate communication, including an e-mail to the candidate, an e-mail from the candidate, a telephone call to or from the candidate, an in person meeting with the candidate, or a voicemail for or from the candidate. An event, other than e-mail communications, may be recorded in the event log 610 by selecting New Contact tool 620. For example, an event may be a welcome e-mail sent from the candidate pool administrator to the candidate, or a record of a phone call from the candidate to the administrator inquiring about a certain position. Selecting an item in the event log generally opens a non-editable full copy of the item.

Utilizing communications with the candidates, administrators responsible for each candidate pool may encourage candidates to apply for positions with certain requirements. As shown in FIG. 1, an application is received from a candidate in step S30. Each candidate application is made part of an individual candidate's record. Once the application is received, in step S35, a copy of the candidate's record is transferred to a hiring system for consideration of the application and potential hiring. An illustrative hiring system and accompanying methods are described in U.S. patent application Ser. No. 09/949,566 filed Sep. 10, 2002, entitled “System and Method for Hiring an Applicant,” the contents of which are incorporated herein in their entirety. It should be appreciated that in at least one embodiment of the invention, a system may embody both the systems and methods of a hiring system, as described in U.S. application Ser. No. 09/949, 566, as well as the present candidate management system.

With the applicant transferred to the hiring system, the management process for that candidate ends in step S40. In at least one embodiment of the invention, the candidate record may remain in the candidate management system following the filing of an application. The candidate, at that point an applicant, may be moved to the candidate pool associated with the position applied for.

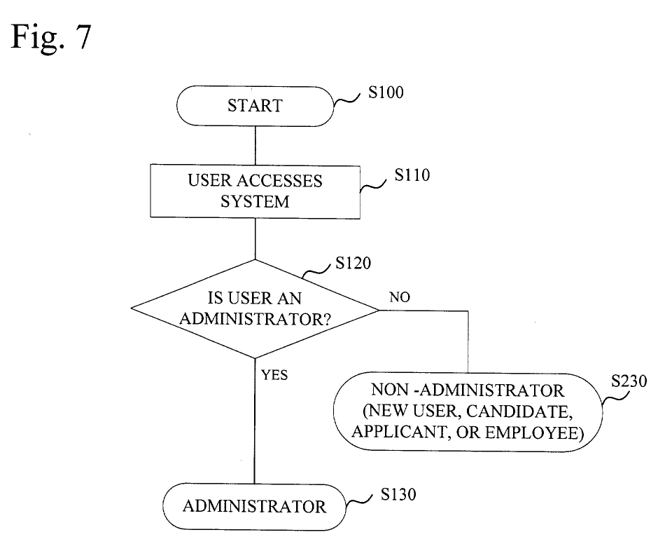

While an illustrative candidate management system has been disclosed for use in facilitating a candidate to apply for a professional position, it should be appreciated that the candidate management system provides several additional features such as those for administrators and non-administrators. Accordingly, FIGS. 7-11 have been provided to further illustrate certain exemplary features.

FIG. 7 is a flowchart illustrating a method of utilizing a candidate management system in accordance with one embodiment of the invention. Once the process begins in step S100, a user accesses the candidate management system in step S110. As described above, the candidate management system may be accessible through an interactive website. Users accessing the candidate management system may be divided into two groups: administrators and non-administrators (i.e., new users, candidates, applicants, and employees). Based on user provided input, the candidate management system determines if the user is an administrator in step S120. For example, administrators may sign in and provide a required authentication input before being allowed access to the administrator features. Those users that are administrators pass to step S130, wherein the administrator features of the candidate management system are presented to the administrator for utilization. Alternatively, non-administrators pass to step S230, wherein the non-administrator features are presented for utilization.

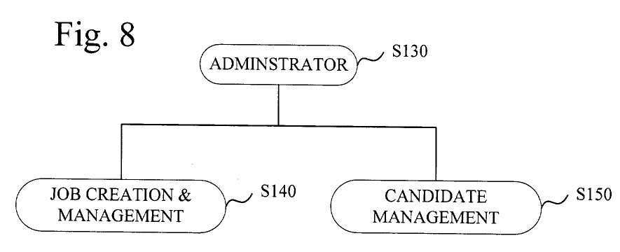

FIG. 8 is a flowchart illustrating the administrator features of FIG. 7 in further detail in accordance with one embodiment of the invention. As shown in FIG. 8, the process begins in step S130, wherein the administrator may choose to utilize job creation and management features, in which case the process passes to step S140, or candidate management features, in which case the process passes to step S150. To provide further illustration, the job creation and management features may allow an administrator to create new job postings, view and edit existing job postings, search existing job postings, for example. When viewing job postings, the administrator may review the job identifier, title, category, professional profile requirements, job description, both detailed and short, the job post date and expiration date, and a contact administrator or other information. Many of these features can be edited when viewing a posting, such as changing the posting status between active, inactive, pending, filled, expired, for example. The administrator may also sort existing postings based on any search criteria, and create new jobs based on an existing job positing.

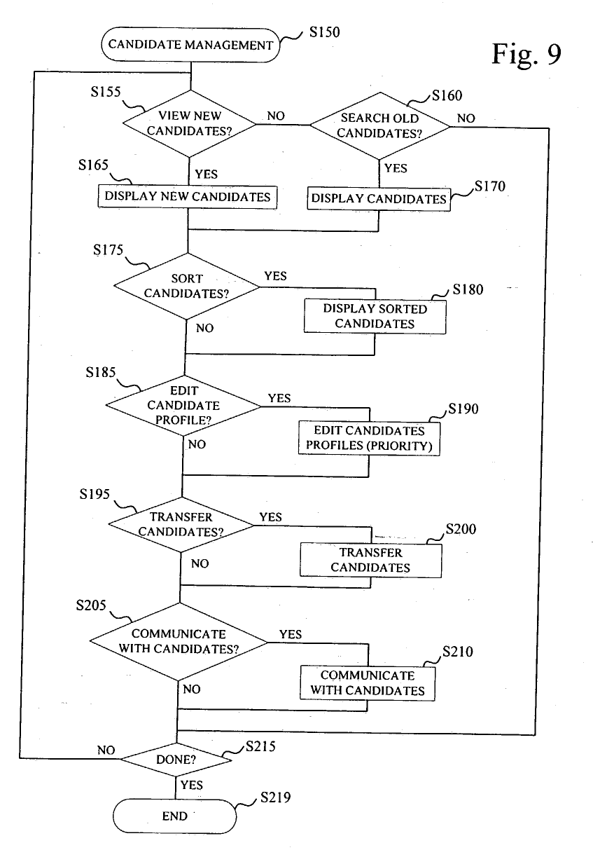

FIG. 9 is a flowchart illustrating the candidate management features of FIG. 6 in further detail in accordance with one embodiment of the invention. As described above, the candidate management features allow the administrators to view candidate information, sort through candidates, provide comments or ratings on particular candidates, and transfer candidates to certain pools for contact by an administrator. In FIG. 9, the process passes from step S150 to step S155, wherein the administrator determines whether or not to view new candidates. If so, the process passes to step S165, wherein the new candidates are displayed to the administrator. However, if the administrator chooses not to view new candidates in step S155, the process passes to step S160, wherein a determination is made whether to search old candidates.

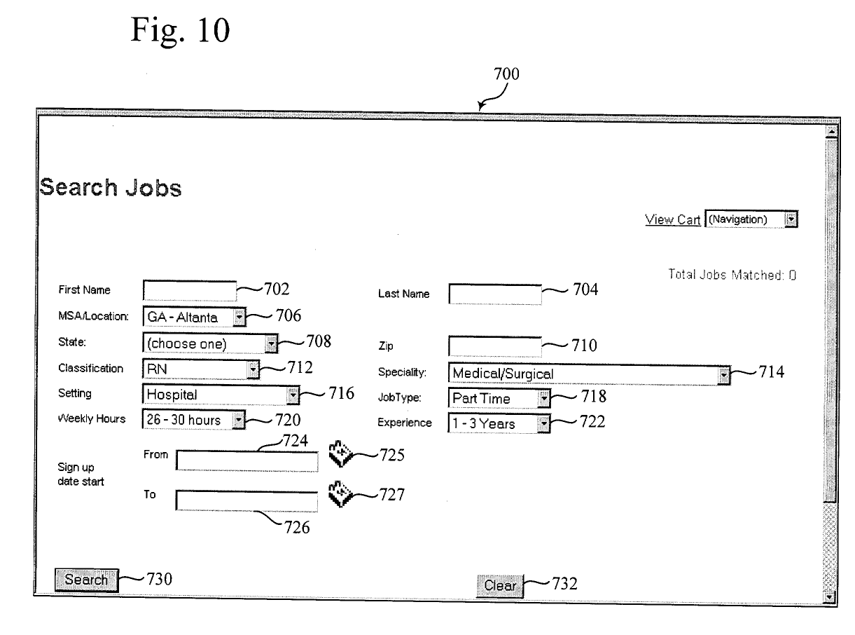

FIG. 10 is an illustrative user interface displaying job search features in accordance with one embodiment of the invention. As shown in FIG. 10, user interface 700 provides a plurality of search fields, each based on a type of candidate information. These search options include first name field 702, last name field 704, MSA/Location field 706, state field 708, zip code field 710, classification field 712, specialty field 714, setting field 716, job type field 718, weekly hours field 720, experience field 722, post date from field 724, calendar tool 725, post date to field 726, calendar tool 727, for example. The administrator may select search tool 730 to run the search with the criteria selected. The clear tool 732 may be selected to reset the search criteria.

If the administrator chooses to search new or existing candidates, the process passes to step S170, wherein the candidates meeting the search criteria entered by the administrator are presented for review. If an administrator chooses not to view candidate information or search candidates, the process skips to step S215, wherein the administrator may be finished utilizing the administrator features.

Following the display of candidate results, the administrator may perform several functions on the candidate records displayed. In step S175, a determination is made whether to sort the candidates. If chosen, the results are sorted in step S180. Then, in step S185, a determination is made whether to edit the candidate's profile. If selected, an individual candidate's profile may edited in step S190. This may include giving an individual candidate a certain priority level. Once the administrator has completed the assessment of the candidates reviewed, the administrator determines whether to transfer any candidates in step S195. Accordingly, candidates may be transferred in step S200. Following the transfer of candidates, the administrator may decide to communicate with candidates in step S205. If selected, the administrator delivers a communication to the candidates in step S215. As shown in FIG. 7, when the administrator is finished, the process passes to step S219, wherein it ends. Otherwise, the process returns to step S155, to begin the utilization of administrator features again.

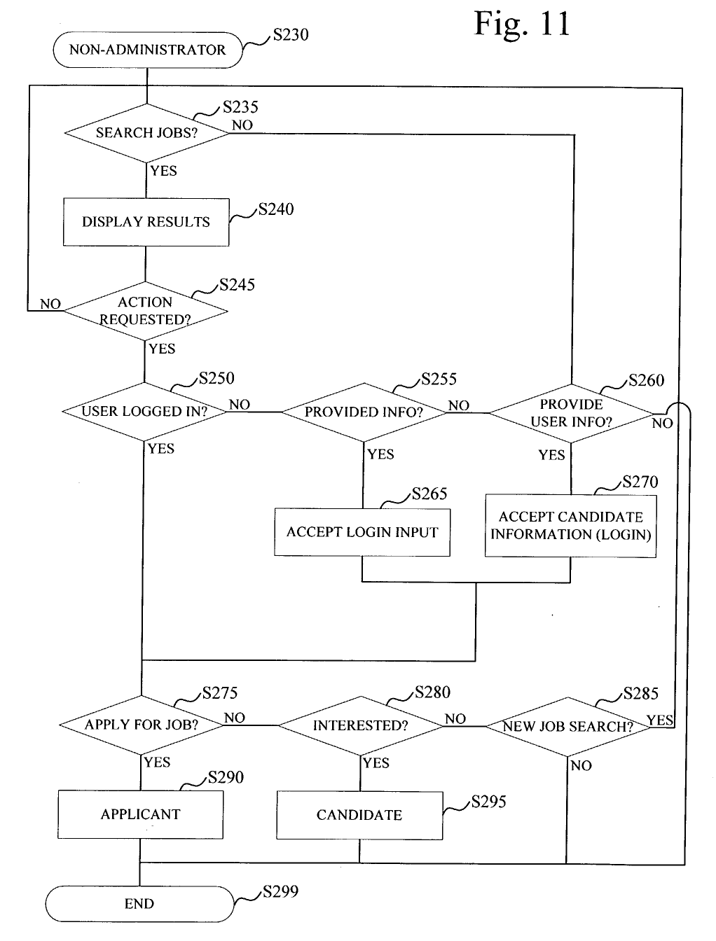

FIG. 11 is a flowchart illustrating the non-administrator features of FIG. 7 in further detail in accordance with one embodiment of the invention. The non-administrator features generally include job or position search capabilities, tools for applying for or indicating an interest in a position, or simply providing candidate information and requesting additional information or communications. Accordingly, following step S230, the process passes to step S235, wherein the user determines whether to search for job or positions posted by the candidate management system, utilizing similar search criteria to those available to administrators. If the search job feature is selected, the process passes to step S240, wherein the search results are presented to the user. Otherwise, if the user chooses not to search for jobs, the process passes to step S260.

Following the display of search results, in step S245, the user is given the opportunity to take further action with respect to the search results, i.e., apply for job or indicate interest. If the user chooses not to take further action on the search results, the process returns to step S235. On the other hand, if the user requests additional action on a particular search result, the candidate management system determines whether the user has logged on, in step S250. If not, the user is given the opportunity to logon if the user has previously provided candidate information to the system in step S255. If the user is not logged on and has not previously provided candidate information, the user is offered the opportunity to provided her information in step S260. Thereafter, if the user does not provide the user's information (both required and professional profile), the process skips to step S299, and the user may not be allowed to take further action with respect to any search results.

For previous users of the candidate management system, login input may be provided in step S265. After providing the login input, the user may return to any search results previously displayed. New users are offered the opportunity to provide candidate information in step S260, and for those that select to do so, the process passes to step S270, wherein the candidate information is accepted. Following receipt of a user's candidate information, the user is treated as having logged onto the system, and is allowed to return to any previously search results as well.

If the system determines that the user is logged on in step S250, has provided login input in step S265 or candidate information in step S270, the user is given the option to apply for a position in step S275. A user that applies for a job then becomes an applicant in step S290, wherein the candidate management system will transfer the candidate's record to a hiring system. A user that does not apply for a position may indicate an interest in a particular position, or future communication from the candidate management system, in step S280. Users that indicate an interest in a particular position will generally be transferred to the candidate pool associated with the position. When a user decides not to apply for a position, or even indicate an interest in a position, the user may begin a new job search in step S285. If the user chooses to begin a new search, the process returns to step S235. Otherwise, the process passes to step S299, wherein the non-administrator may cease using the candidate management system ends.

As described above, once the candidate management system receives information from a candidate, that information may be stored in an associated candidate record. Thus, in accordance with one embodiment of the invention, the candidate management system may take the form a computer operating system or other processing machine managing a relational database of job-related information, including candidate information (both required and professional profile information) from each candidate, administrator comments or evaluations of candidate information, information on job postings and associated criteria, for example.

Utilizing a relational database system provides additional benefits because it allows information contained in different tables to be accessed and shared by different users, while also providing the additional advantage that changes to data contained in one table of a relational database affects the same data in any other table sharing the same data. The candidate information submitted to the candidate management system may be stored in a candidate record and viewed by several different administrators that each may have particular needs for candidates. Each of these administrators could rate a candidate, view information or transfer them into a specialized pool. A candidate may also need to amend certain candidate information submitted to the candidate management after the initial submission of information. Utilizing the candidate features, the candidate can edit his candidate information stored in the system and that information will be updated from that point forward.

To provide further understanding, a table is a collection of several data records with similar data information fields. An individual table may represent a given candidate pool, wherein in one field, the candidate records in the table share the same data. In the embodiment described above for nursing candidates, the fields for a particular table (or candidate pool) may include specialty, job type, availability or any other category of information requested for the professional profile, as well as data fields for administrators to make comments or edits to the candidate's profile. Data records represent a collection of data that is organized into fields. These fields may also be formatted to receive data of varying types such as alphanumeric, numeric or simple characters, for example. In one aspect, for candidate's that provide resumes or imaged copies of a resume, one field of a candidate's record may include a link to another file stored in the system representing the resumes. Accordingly, the database user can view data records in a user interface, input or edit the data contained in the various fields, or issue a database query that retrieves and reports information from multiple tables.

Although certain aspects of the invention have been described utilizing an interactive website, it should be appreciated that users, candidates, applicants, employees and administrators may access the candidate management system via any suitable communication interface, Ethernet connection, modem, telephone, digital or analog connections with the system using wireless communication devices (i.e., mobile phones, PDAs, or other handheld wireless communication devices), token ring, Internet or Intranet or other computer or electronic connection, or any other suitable network connection that allows the user to receive input from and send output to the candidate management system.

### An Illustrative Candidate Management System

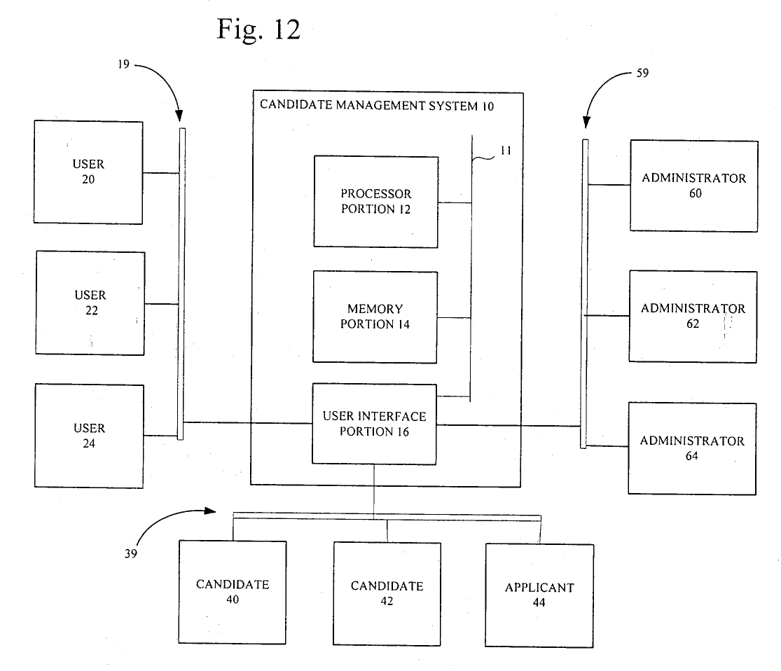

FIG. 12 is a diagram showing an illustrative candidate management system in network communication in accordance with one embodiment of the invention. FIG. 2 shows candidate management system 10, a plurality of users 20, 22, and 24, a plurality of candidates 40 and 42, an applicant 44, and a plurality of administrators 60, 62, and 64. Each user 20, 22 and 24 is in selective network communication with the candidate management system 10 through user network 19. Each candidate 40 and 42, and applicant 44 is in selective network communication with the candidate management system 10 through candidate network 39.

Each administrator 60, 62 and 64 is in selective network communication with the candidate management system 10 through administrator network 59. It should be appreciated that user network 19, candidate network 39 and administrator network 59 may be the same network in at least one embodiment of the invention. For example, as described above, the candidate management system 10 may operate an interactive website accessible over the Internet, through which users, candidates, applicants and administrators may utilize the available features. For each type of user of the candidate management system 10, any suitable network connection, as described herein, may be employed to communicate with, provide input to, and receive input from the candidate management system 10 or administrator.

As shown in FIG. 12, the candidate management system 10 includes a processor portion 12 for processing input from and generating output to the various users, candidates, applicants and administrators in communication with the candidate management system 10. Candidate management system 10 further includes a memory portion 14. In operation, the processor portion 12 retrieves data from and stores data for use by the candidate management system 10 in the memory portion 14.

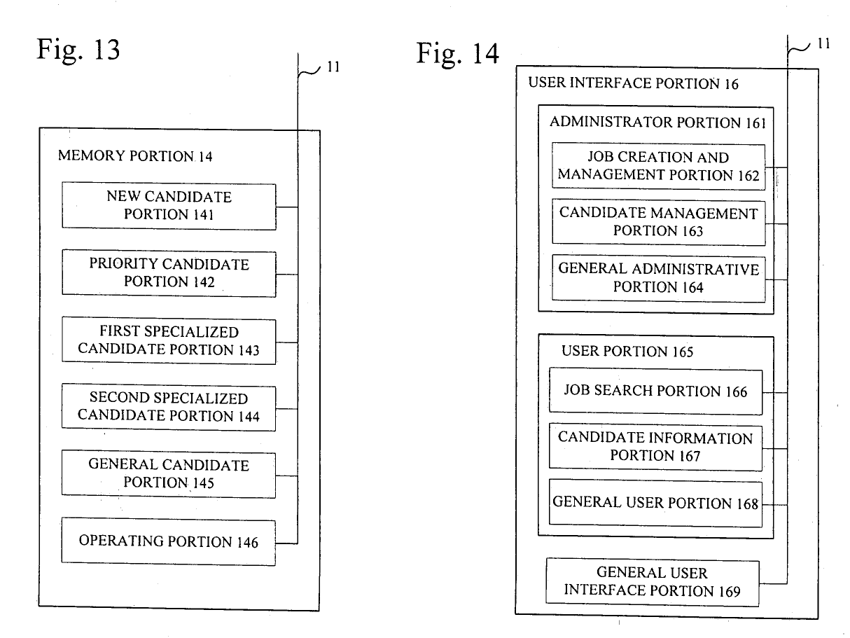

FIG. 13 is a schematic drawing of the memory portion of FIG. 12 in further detail in accordance with one embodiment of the invention. As shown in FIG. 13, memory portion 14 includes a new candidate portion 141, a priority candidate portion 142, a first specialized candidate portion 143, a second specialized candidate portion 144, general candidate portion 145 and an operating portion 146. New candidate portion 141 is utilized to store candidate records, including candidate information submitted by new candidates to the candidate management system 10. When an administrator needs to review new candidate information, the processor portion retrieves the relevant records from the new candidate portion 141, and provides them to the user interface portion 16 for display to the administrator.

As described above, certain candidates may be given priority, or ranked as the most attractive candidates, and transferred to a priority candidate pool, and stored in the priority candidate portion 142. Also, candidates may also be transferred to any number of specialized candidates pools based on the candidate information provided and the criteria for specialized pools as determined by administrators. Illustratively, first specialized candidate portion 143 and second specialized candidate portion 144 may be utilized to store candidate records and information for two special groups of candidates. For example, first specialized candidate portion 143 may be used to store candidate records for those candidates interested in working in a particular location, such as Baltimore. Second specialized candidate portion may be utilized to isolate nursing candidates that are interested in working in Atlanta, Ga., in the medical/surgical specialty, for example. General candidate portion 145 may be used to store candidate records that do not get placed within a specialized candidate portion. Operating memory portion 146 may be utilized to store any other necessary data and information for the operation of the candidate management system 10.

It should be appreciated that the various memory components contained in the memory portion 14 may take on a variety of architectures as is necessary or desired by the particular operating circumstances. Further, the various memory components of the memory portion 14 may exchange data or utilize other memory component data utilizing known techniques, such as relational database techniques.

As shown in FIG. 12, candidate management system 10 further includes a user interface portion 16 for accepting input from and transmitting output to the various users, candidates, applicants and administrators communicating with the candidate management system 10. The user interface portion 16 provides the interface through which the users can provide input to and receive output from the candidate management system 10. The user interface portion 16 is controlled by the processor portion 12, or components thereof, to interface with a user or other operating system, including inputting and outputting data or information relating to the candidate management system 10.

FIG. 14 is a schematic of the user interface portion of FIG. 12 in further detail in accordance with one embodiment of the invention. As shown in FIG. 14, user interface portion 16 includes an administrator portion 161, a user portion 165, and a general user interface portion 169. Administrator portion 161 further includes a job creation and management (“JCM”) portion 162, a candidate management portion 163, and a general administrative portion 164. As described above, the candidate management system 10 provides capabilities for administrators and non-administrators (i.e., user, candidates or applicants). Administrator portion 161 displays the functions and features available to authenticated administrators. These features fall generally into two categories: job creation and management (presented by JCM portion 162), and candidate management (presented by candidate management portion 163). Other administrative features of the system may be presented by the general administrative portion 164.

On the other hand are the features and capabilities available to non-administrators accessing the candidate management system 10. These generally include: job search (presented by the job search portion 166), and the submission of user information (presented by the candidate information portion 167). Other non-administrator user features of the system may be presented by the general user portion 168. As shown in FIG. 14, user interface portion 16 further includes a general user interface portion 169, which is generally responsible for remaining user interaction features and capabilities not presented by the administrative portion 161 or user portion 165.

Referring to FIG. 12, each of the processor portion 12, memory portion 14 and user interface portion 16 are connected to and in communication with each other through a data bus 11. It should be appreciated that the candidate management system 10 may utilize components from each of the processor portion 12, memory portion 14 and user interface portion 16.

It should be appreciated that the system of the invention or portions of the system of the invention may be in the form of a “processing machine,” such as a general purpose computer or other network operating system, for example. As used herein, the term “processing machine” is to be understood to include at least one processor that uses at least one memory. That at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above in the flowcharts. Such a set of instructions for performing a particular task may be characterized as a program, software program, or simply software.

As described above, the processing machine executes the instructions that are stored in the memory or memories to process data. This processing of data may be in response to commands by a user or users of the processing machine, in response to previous processing, in response to a request by another processing machine and/or any other input, for example.

As stated above, the processing machine used to implement the invention may be a general purpose computer. However, the processing machine described above may also utilize any of a wide variety of other technologies including a special purpose computer, a computer system including a microcomputer, mini-computer or mainframe for example, a programmed microprocessor, a micro-controller, an integrated circuit, a logic circuit, a digital signal processor, a programmable logic device, or any other device or arrangement of devices that is capable of implementing the steps of the process of the invention.

It is appreciated that in order to practice the method of the invention as described above, it is not necessary that the processors and/or the memories of the processing machine be physically located in the same geographical place. That is, each of the processors and the memories used in the invention may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing as described above is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, WAN, VAN, an Ethernet, or any client server system that provides communication, for example. Such communications technologies may use any suitable protocol such as TCP/IP, UDP, or OSI, for example.

The set of instructions used in the processing of the invention may be in the form of a program or software. The software may be in the form of system software, application software, a collection of separate programs, a program module within a larger program, or a portion of a program module, for example The software used might also include modular programming in the form of object oriented programming.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, a EPROM, a wire, a cable, a fiber, communications channel, a satellite transmissions or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may be in the form of a web page or other interactive application presented on a user system by the user's browser, for example. The web page or application could include fields for accepting data and transmitting data to the advertising marketing system for storage. A user interface may also include any of a mouse, touch screen, keyboard, keypad, card slot, voice reader, voice recognizer, dialogue screen, menu box, list, checkbox, toggle switch, a pushbutton or any other device that allows a user to receive information regarding the operation of the processing machine as it processes a set of instructions and/or provide the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

Many embodiments and adaptations of the present invention other than those herein described, will be apparent to those skilled in the art by the foregoing description thereof, without departing from the substance or scope of the invention. While the present invention has been described herein in detail in relation to its exemplary embodiments, it is to be understood that this disclosure is only illustrative and exemplary of the present invention. Accordingly, the foregoing disclosure is not intended to limit the scope of the present invention which is defined by the claims and their equivalents.

What is claimed is:

1. A method of facilitating a candidate to apply for a professional position, comprising:
accepting candidate information from the candidate;
assessing the candidate information;
transferring the candidate information to an associated candidate pool;
communicating with the candidate based on the associated candidate pool; and
receiving application input from the candidate for the professional position.

2. The method of claim 1, wherein the candidate information includes required information and professional profile information.

3. The method of claim 1, wherein the candidate information includes at least one of a candidate specialty, setting, job type, weekly hours, availability, experience, career goals, location preference, notification preferences, and resume preferences.

4. The method of claim 1, wherein the candidate information is stored in an associated candidate record.

5. The method of claim 1, wherein accepting candidate information further includes:
creating an associated candidate record for the candidate; and
storing the candidate information in the associated candidate record.

6. The method of claim 1, wherein assessing the candidate information further includes:
viewing the candidate information in the new candidate pool;
determining the associated candidate pool to transfer the candidate information based on the professional profile information.

7. The method of claim 1, wherein the associated candidate pool has predetermined professional profile criteria for candidates.

8. The method of claim 1, wherein communicating with the candidate includes delivering an electronic communication to the candidate.

9. The method of claim 8, wherein the electronic communication is an e-mail designed to encourage the candidate to apply for a professional position.

10. The method of claim 1, wherein communicating with the candidate includes telephoning the candidate.

11. The method of claim 1, further including transferring the candidate to a hiring system.

12. The method of claim 11, wherein transferring the candidate to a hiring system further includes transferring an associated candidate record to the hiring system.

13. A method of operating a candidate management system to facilitate a candidate to apply for a professional position, comprising:
accepting by the candidate management system candidate information from the applicant;
assessing by an administrator the candidate information;
transferring by the administrator the candidate information to an associated candidate pool;
utilizing by the administrator, the candidate management system to communicate with the candidate based on the associated candidate pool; and
receiving by the candidate management system application input from the applicant for the professional position.

14 A method of managing a candidate, comprising:
assessing candidate information provided by the candidate, the candidate information including required information and professional profile information;
placing the candidate in an associated candidate pool based on the professional profile information; and
communicating with the candidate based on the associated candidate pool, wherein at least one communication is sent to the candidate designed to encourage the candidate to apply for a professional position.

15. A candidate management system, comprising:
means for accepting candidate information from a candidate system;
means for assessing the candidate information;
means for transferring the candidate information to an associated candidate pool;
means for communicating with the candidate system based on the associated candidate pool; and
means for receiving application input from the candidate system for the professional position.

16. A candidate management system, comprising:
means for assessing candidate information provided by a candidate, the candidate information including required information and professional profile information;
means for placing the candidate information in an associated candidate pool based on the professional profile information; and
means for communicating with the candidate based on the associated candidate pool to encourage the candidate to apply for a professional position.
